(19) United States
(12) Patent Application Publication
(10) Pub. No.: US 2012/0087760 A1
(43) Pub. Date: Apr. 12, 2012

(54) UPRIGHT SIDE SUPPORT BEAM SYSTEMS FOR SHIPPING CONTAINERS USED WITH BULK LIQUID CARGO

(75) Inventor: David M. Sims, Houston, TX (US)

(73) Assignee: Environmental Packaging Technologies Ltd.

(21) Appl. No.: 12/901,363

(22) Filed: Oct. 8, 2010

(51) Int. Cl. B60P 1/64; B23P 11/00

(52) U.S. Cl. 410/52; 29/428

(57) ABSTRACT

An energy-absorbing upright support system apparatus includes high-strength roll formed tubular bars, and a bar-supporting sheet to distribute stress from product shifting in large shipping containers during transport. Parts are re-useable and can be quickly installed into the shipping container at selected locations such as near the container's doors. The bars can be swept and/or have deformed/configured ends shaped to engage channel features in side walls of the large shipping container. The bars may define spaced tubes and a tie rod for added strength. For example, the bars can be steel having 120 KSI to 220 KSI tensile strength, and have a cross-section 2-3 inches in depth and 4-6 inches in height, a length of 94 long, and a longitudinal sweep of 6 inches curvature.

### BACKGROUND

1. Technical Field

The present disclosure relates to support beams, and support beam systems, for rigid shipping containers used to transport product-filled or partially-product-filled bulk liquid cargo tanks, for example but not limited to flexitanks.

2. Description of Related Art

As noted above, the particular type of rigid shipping container to which this application is directed is one that includes a bulk liquid cargo vessel, for example, but not limited to, large single or multi-layered flexitanks, such as that known under the trade designation “BIG RED FLEXITANK®”, available from Environmental Packaging Technologies, Ltd., assignee of the present patent. In actual use during shipping, bulk liquid cargo vessels are frequently used in combination with a large, box-shaped, rigid shipping container. In the case where the bulk liquid cargo vessel is a flexitank, when assembling these types of shipping apparatus, the initially-empty flexitank is placed inside the rigid container. Typically, reinforcing bars and a woven sheet are then installed to form a barrier between the flexitank and the open end of the rigid container, which also functions as a barrier after the container doors are closed. The installation of the woven sheet typically includes strapping it in place. Cargo, such as liquid or granular material, is then introduced to the inside of the flexitank, typically through a discharge or inlet valve. After the flexitank is filled, the container door(s) are rotated to a closed position. The resulting apparatus is primarily used to transport the cargo for great distances, typically over water, on barges or other types of oceangoing vessels, and also sometimes over land by railway, and in airplanes. For example, see Grogan U.S. Pat. No. 5,141,122. These containers are normally designed to withstand significant impact loads and stress that may occur during loading and transport, including impacts from adjacent containers and also from product shifting internally during transport. The door-located end of containers is often problematic, and therefore has received most of the attention in terms of strengthening, because it is difficult to make a door and door-supporting structure “strong enough” to withstand impact without also adding excessive cost and weight to the container. Damage to doors can result in constant maintenance and expense. For example, when sorting railroad cars in a rail yard, the cars may encounter substantial jarring and high impact loads in excess of 75,000 pounds force as the railroad cars are rolled into one another for reconnection. Also, wave action can cause large ships to roll and tilt, resulting in product shifting during transport, and resulting in substantial stress on and/or damage to a container, including its doors.

Despite strengthening the doors through use of various upright support system systems, many shipping container apparatus in use today suffer from various shortcomings in their sidewall strength. One problem is that the rigid shipping container is often constructed to meet certain standards, such as International Standards Organization (ISO) standards, but using a minimum of cost and materials in order to meet those standards. For example, as discussed in Published U.S. Pat. App. No. 20030146212, improvements to meet ISO standards normally add to the cost and tare weight of shipping containers. Embodiment 2 discussed in the '212 document discusses improvements to side panels of the rigid shipping container. However, these improvements are in the corrugated plate crest and trough features. The crest height and trough depth are increased, and other dimensions are changed, and the thickness of the metal decreased. No mention is made of problems with transport of bulk liquid cargo vessels, or in strengthening sidewall panels of rigid shipping containers using upright support beams.

There have been various systems and methods proposed in the bulk liquid cargo art to increase the support for the vessel when shipped in a container, but these efforts have largely focused on support during longitudinal movement of (or a portion thereof) the bulk liquid cargo vessel in the rigid shipping container. None to the inventors' knowledge recognizes the problem of bulging of the shipping container sidewalls after loading of product into a bulk liquid cargo vessel, whether the product is liquid, solid, granular or particulate material, due to product bulging of the vessel, or due to side wave action, or other movement of product in the vessel. Therefore no one has proposed a solution to this unique problem. U.S. Pat. Nos. 4,136,713 and 4,223,709 disclose flexitanks used for bulk shipping having various lifting loops and belts for supporting the containers when off-loading. U.S. Pub. Pat. App. No. 20020084202 discloses corrugated shipping containers having support beams, but the support beams are not welded, and do not extend vertically between the roof and floor of the rigid shipping container. U.S. Pub. Pat. App. No. 20080135545 discloses “upright panels”, for example upright side and end wall panels, but not support beams. A bottom end wall panel may be connected to a perimeter end beam by welding. The afore-mentioned U.S. Pat. No. 5,141,122 mentions a rigid shipping container strengthened by vertical ribs along its sidewalls, but no details are given as to the structure of these ribs. Vertical support posts are provided at each corner of the shipping container, and are “generally of sufficient strength to support a plurality of containers there-above”, but these are not removable or stackable when not in use, and there is no discussion or recognition of the problem of bulging bulk liquid cargo vessels, and their possible negative impact on the side walls of the shipping container, or of possible damage to the bulk liquid cargo vessels themselves. In short, none of these references recognizes any problem with bulging of bulk liquid cargo vessels such as flexitanks on the side walls of the rigid shipping container, and so no solution has been presented to this problem.

Temporary structures (i.e., upright support systems) are often built within rigid shipping containers to keep product from shifting. These structures are built out of a variety of different products, such as wood, metal, plastic, and sheet material. They can include padding and/or other stress-distributing member(s). However, such temporary structures are often “custom” installations that take significant time and labor to construct. As a result, they are inefficient to construct, unreliable in strength, often are not as strong as desired, and often result in considerable waste since their materials are often damaged or destroyed when removed such that they cannot be reused. Further, they often lack simplicity of components and interconnecting structure.

Sometimes, liquids and flowable materials are shipped in the large rectangular shipping containers, with the liquids being contained by liquid-tight containers, such as barrels, drums and/or tanks. Aside from the risk of these liquid-tight containers shifting, the liquids and flowable materials themselves can wash and flow laterally in response to lateral-forces during shipment, adding to peak lateral forces during transport. Notably, there is a load limit on liquid products that can be carried within a given shipping container, such that the liquids often do not fill their respective liquid-tight containers, which lets the liquids build up momentum as they wash and ebb and flow laterally. Thus, there is an additional risk where liquid product itself shifts, aggravating the problem by adding to peak stresses and cyclical lateral impact loads.

Bulk liquid cargo vessels in particular can be sensitive to the forces caused by liquids washing and flowing laterally within them. Specifically, as such vessels are shaped to more closely fit within a rectangular shipping container, their side walls become flatter, making them more prone to bulging outward when they are filled. The side walls bulge outward even farther when their internal liquid washes and/or flows laterally due to side forces and movement during shipment.

It would be advantageous if upright support beams and systems could be developed that safely and efficiently allow the side walls of rigid shipping containers to be strengthened while in use with full or partially-filled bulk liquid cargo vessels. It would further be advantageous if these upright beams and systems could be easily removed and easily stacked, by personnel or machines, for multiple re-use. The beams, systems and methods of the present disclosure are directed to these needs.

### SUMMARY

One aspect of the present disclosure is a removable, upright, stackable side wall support system apparatus for a shipping container including container side walls defining an access opening and at least one door for closing the access opening, the side walls (or at least a portion thereof) being corrugated, the wall support system apparatus comprising:
a) a pair of mounting brackets, the mounting brackets separated by a distance equal to or less than a height of the side walls, the mounting brackets each comprising first and second bars welded together at intermittent locations along their lengths, one of the bars having a corrugated shape to fit matingly into the corrugations of the side walls of the shipping container; and
b) at least one connecting beam having ends removably fastened to the mounting brackets.

In certain embodiments, the connecting beams have a cross-section allowing two or more apparatus to be stacked after being removed from the shipping container. In certain embodiments, the connecting beams have a structure selected from the group consisting of at least one tube section (D-beam), at least two spaced-apart tube sections (B-beam), rectangular, “W” and “U” cross-sections. In certain embodiments, the connecting beams are fastened to the support brackets using one or more bolts. In yet other embodiments, the connecting beams are curvilinear and curve away from the corrugations of the mounting brackets and the shipping container walls, in other words curve in toward a bulk liquid cargo vessel being carried by the shipping container.

Certain embodiments comprise two mounting brackets and two connecting beams, the connecting beams fastened to the mounting brackets at equal distances away from respective ends of the mounting brackets.

In certain embodiments, each mounting bracket has a length “A”, and each connecting beam is fastened to the mounting brackets at a distance away from ends of the mounting brackets ranging from 0.1A to 0.3A.

In certain embodiments, the connecting beams have a length “B” and curve such that a point that is furthest away from a line including both ends of the connecting beam ranges from 0.01B to 0.1B. In certain embodiments, the at least one connecting beam is longitudinally swept so as to position a middle of the bar at least about 1 inch forward of ends of the bar.

In certain embodiments the ends of each of the connecting beams include end sections that are co-linear and aligned.

In certain embodiments the ends of the at least one connecting beam include a deformed and flattened side surface.

In certain embodiments the connecting beam is made of sheet material having a material strength at least about 40 KSI tensile strength, in certain embodiments at least about 80 KSI, and in some embodiments at least about 120 KSI.

In certain embodiments the at least one connecting beam's ends are configured to releasably extend into and directly engage the floor, ceiling, and/or side walls of the container. Certain embodiments include brackets attached to the floor, ceiling, and/or side walls of the container engaging the ends of the at least one connecting beam.

Another aspect of the disclosure is an energy-absorbing, removable, upright, stackable support system apparatus for use in strengthening side walls of a shipping container, the shipping container including container side walls defining an access opening and opposing channel features, at least one door for closing the access opening, the upright support system apparatus comprising:
a) a pair of mounting brackets, the mounting brackets separated by a distance equal to or less than a height of the side walls, the mounting brackets each comprising first and second bars welded together at intermittent locations along their lengths, one of the bars having a corrugated shape to fit matingly into the corrugations of the side walls of the shipping container; and
b) at least two connecting beams having ends removably fastened to the mounting brackets, wherein the connecting beams are curvilinear and curve away from the corrugations of the mounting brackets and the shipping container walls.

In certain embodiments, the connecting beams each include a swept center section. In other embodiments, the connecting beams each define a pair of spaced-apart tubes.

Another aspect of the disclosure is a method of constructing an energy absorbing upright support system for side walls within a shipping container or truck trailer, the method comprising:
a) providing a pair of mounting brackets, the mounting brackets separated by a distance equal to or less than a height of the side walls, the mounting brackets each comprising first and second bars welded together at intermittent locations along their lengths, (in certain embodiments at least one of the bars having a corrugated shape to fit matingly into the corrugations of the side walls of a shipping container); and
b) at least two connecting beams having ends removably fastened to the mounting brackets, wherein the connecting beams are curvilinear and curve away from the shipping container walls (and away from corrugations of the mounting brackets, in brackets having corrugations),
wherein the upright support system forms a temporary structure that prevents product from unacceptably shifting against a container corrugated side wall.

Another aspect of the disclosure is a method of constructing a temporary upright support system for side walls of a container, in certain embodiments corrugated side walls in a container, comprising:
preforming at least one connecting beam of metal;
supporting ends of the at least one connecting beam vertically using mounting brackets having a surface (in certain embodiments a corrugated surface) positioned adjacent the side walls of the container (in certain embodiments the corrugated side walls of a container) to form an upright support system preventing a product (for example a full or partially full flexitank or other bulk liquid cargo vessel) from shifting against the side walls during shipment;
dismantling the upright support system; and
later reusing the system in another container.

Certain methods include sweeping the at least one connecting beam so that, when positioned in a container-supported position, a center of the at least one connecting beam is spaced away from the at least one planar or corrugated side wall a greater distance than ends of the at least one connecting beam. Certain methods comprise including a step of attaching mounting brackets to corrugated side walls of the shipping container on each side thereof, and attaching the at the least one connecting beam to the mounting brackets, the mounting brackets having corrugated surfaces mating with the corrugations of the side walls.

Certain methods include rollforming the connecting beam from metal sheet material of at least about 80 KSI tensile strength. Certain other methods include rollforming the connecting beam to have a cross-section defining at least a pair of tubes.

Certain methods include placing a bulk liquid cargo vessel, such as an IBC or flexitank, within the container and, after forming the upright support system, filling the vessel so that a side of the vessel presses against the upright support system.

Another aspect of the disclosure is a kit for supporting a planar or corrugated side wall of a shipping container when used with a full or partially full bulk liquid cargo vessel such as a flexitank, the kit comprising:
a) a bulk liquid cargo vessel comprising at least one product inlet or at least one product outlet;
b) first and second conduits, the first conduit routing a fluid into the vessel, the second conduit routing product out of the vessel during off-loading;
c) an upright support system apparatus for supporting planar or corrugated side walls of the container comprising:
   i) a pair of mounting brackets, the mounting brackets separated by a distance equal to or less than a height of the side walls, the mounting brackets each comprising first and second bars welded together at intermittent locations along their lengths, one of the bars having a planar or corrugated shape to fit matingly into the corrugations of the side walls of the shipping container; and
   ii) at least two connecting beams having ends removably fastened to the mounting brackets, wherein the connecting beams are curvilinear and curve away from the shipping container walls; and
d) means for deterring collapse of the vessel during off-loading of the product.

Certain kits include those wherein the bulk liquid cargo vessel is a flexitank, and the flexitank is substantially seemless. Other kits are those wherein the means for deterring collapse are fasteners selected from one or more snaps, loops, hook and loop fasteners, and combinations thereof, securely attached to an external surface of the bulk liquid cargo vessel in a fashion so that the fasteners are able to engage in a cooperative, supporting fashion with a rigid container into which the vessel has been placed, thereby substantially deterring collapse of the vessel.

Useful flexitanks for use in the apparatus, systems and methods of this disclosure include “substantially seemless” flexitanks, as well as more conventional seemed flexitanks. As used herein the phrase “substantially seemless” means that the flexitank is formed from a tube of flexible material and has at most two seems, one on each end of the tube as further illustrated and explained herein.

These and other aspects, objects, and features of the present disclosure will be understood and appreciated by those skilled in the art upon studying the following specification, claims, and appended drawings.

### BRIEF DESCRIPTION OF DRAWINGS

The manner in which the objectives of this disclosure and other desirable characteristics can be obtained is explained in the following description and attached drawings in which:

FIG. 1 is a perspective view of the door-containing end of a shipping container for moving bulk product, the container including two opposing doors over its access opening;

FIG. 2 is an exploded view of FIG. 1, with the container's roof exploded away and showing a liner and a flexitank, and also illustrating an upright support system apparatus of the disclosure for supporting a sidewall of the shipping container;

FIGS. 3A-3D are schematic perspective, front elevation, plan, and side elevation views, respectively, of one embodiment of an upright support system apparatus in accordance with the present disclosure;

FIGS. 4A and 4B are detailed perspective and detailed side elevation views, respectively, of the connection between the mounting bracket and a mounting beam of the embodiment illustrated in FIGS. 3A-3D;

FIGS. 5A-5D are schematic perspective, front elevation, plan, and side elevation views, respectively, of a second embodiment of an upright support system apparatus in accordance with the present disclosure;

FIGS. 6A and 6B are detailed perspective and detailed side elevation views, respectively, of the connection between the mounting bracket and a mounting beam of the embodiment illustrated in FIGS. 5A-5D;

FIGS. 7A, 7B, and 7C are side elevation, plan, and close detail views of a mounting bracket of this disclosure;

FIGS. 8-10 are plan, front elevation, and transverse cross-section of a connecting beam useful in the support systems of this disclosure, and FIG. 11 is an enlarged plan view of the end of one such beam;

FIGS. 12 and 13 are perspective and plan views of a single tube beam defining only a single tube, and FIG. 14 is a transverse cross-section through the beam of FIGS. 12-13 to illustrate its cross-sectional shape; and

FIGS. 15-18 illustrate a connecting beam similar to beam of FIG. 8 in cross-section, having spaced tubes and channel ribs in its door-remote (interior-positioned) wall over each tube, with configured ends with trapezoidal shape.

It is to be noted, however, that the appended drawings are not to scale and illustrate only typical embodiments of this disclosure, and are therefore not to be considered limiting of its scope, for the systems and methods of the disclosure may admit to other equally effective embodiments. Identical reference numerals are used throughout the several views for like or similar elements.

### DETAILED DESCRIPTION

In the following description, numerous details are set forth to provide an understanding of the disclosed methods and apparatus. However, it will be understood by those skilled in the art that the methods and systems may be practiced without these details and that numerous variations or modifications from the described embodiments may be possible.

All phrases, derivations, collocations and multiword expressions used herein, in particular in the claims that follow, are expressly not limited to nouns and verbs. It is apparent that meanings are not just expressed by nouns and verbs or single words. Languages use a variety of ways to express content. The existence of inventive concepts and the ways in which these are expressed varies in language-cultures. For example, many lexicalized compounds in Germanic languages are often expressed as adjective-noun combinations, noun-preposition-noun combinations or derivations in Romantic languages. The possibility to include phrases, derivations and collocations in the claims is essential for high-quality patents, making it possible to reduce expressions to their conceptual content, and all possible conceptual combinations of words that are compatible with such content (either within a language or across languages) are intended to be included in the used phrases.

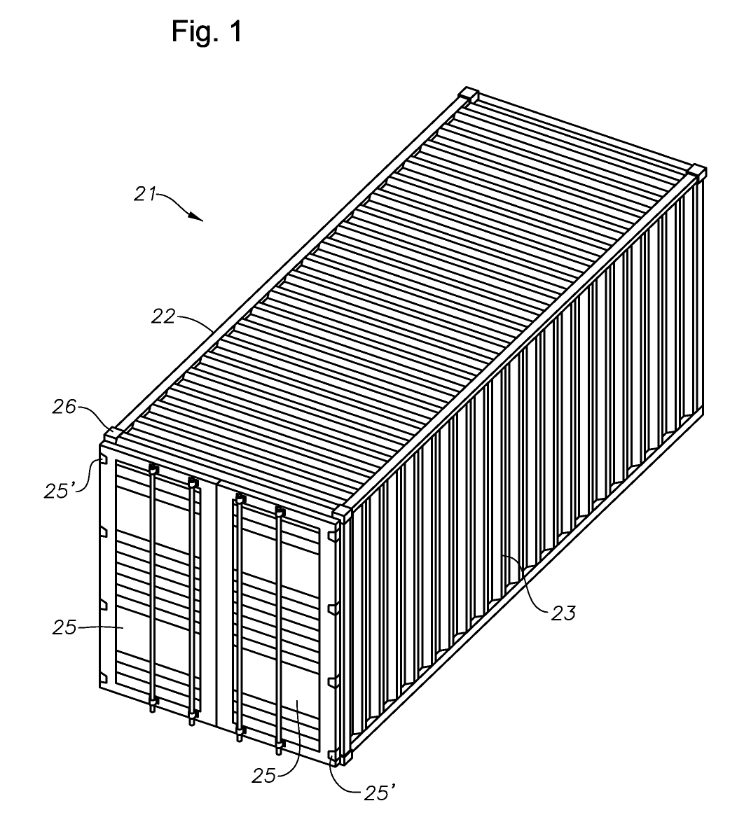

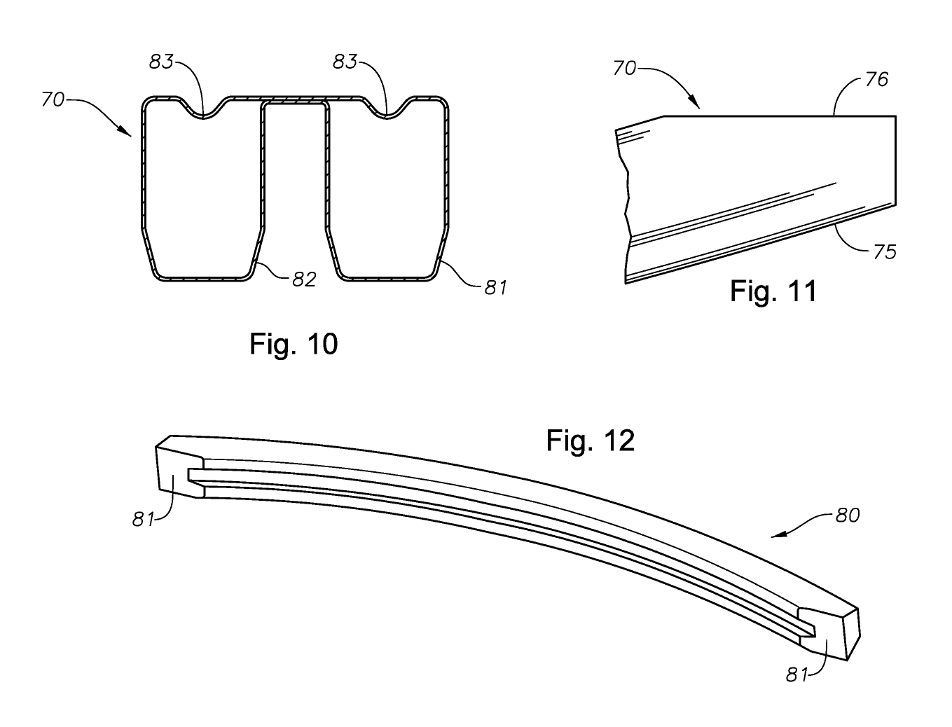

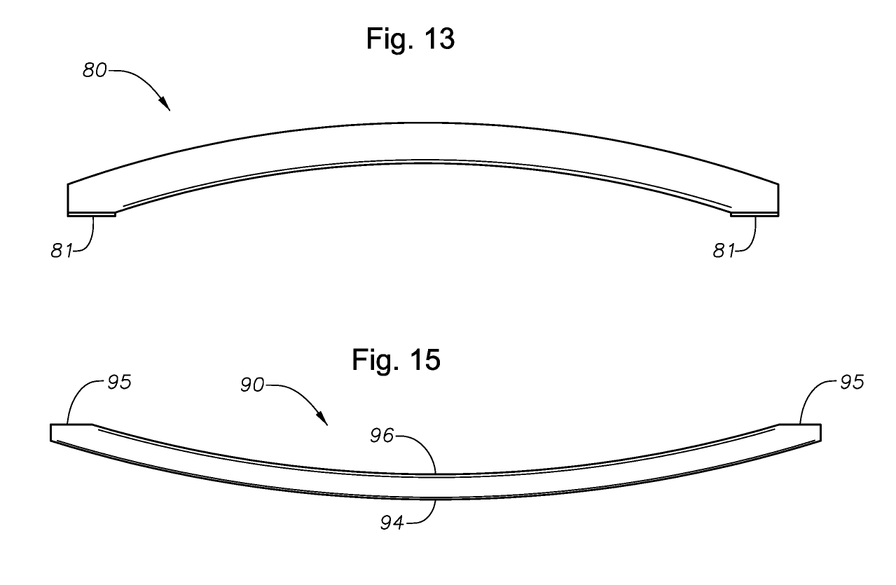

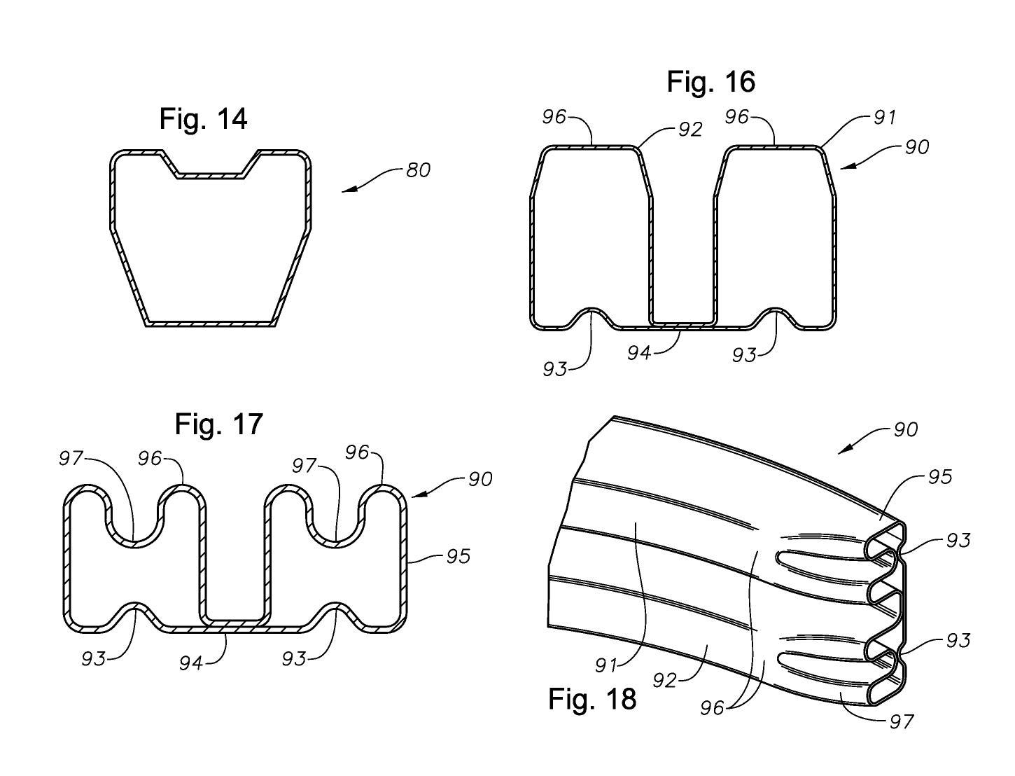

Certain claims herein include a reference to a “flexitank.” As used herein, a “flexitank” is defined as any flexible structure having a length and width, inner surface(s), outer surface(s), an interior (inside) capable of holding liquids or flowable solids (or solids consolidated into one or more solid mass that is/are capable of being made flowable as a slurry, as taught herein), one or more openings through which fluid is capable of passing into or from the inside of the flexitank, and one or more openings through which slurried granular product is capable of passing from the inside of the flexitank. There are many different sizes and types (embodiments) of flexitanks, e.g., different categories and/or subcategories of flexitanks. For example, different types of flexitanks may have or include different sizes, shapes, materials and components (e.g., fixtures and/or hardware, including fittings). Thus, unless specified otherwise, or unless apparent from the context, all references herein to a “flexitank” encompass any and all of the many different types of flexitanks, modified as taught herein to off-load slurried granular products. The flexible material component of the flexitank can be, for example, a single-layered bag or a multi-layered bag. The flexitank can also be a combination of bags or layers or liners in which one or more bags or layers or liners are disposed inside of one or more other bags or layers or liners (discussed below). Alternatively, the flexitank can be a laminated bag, comprising different layers laminated together. As discussed herein, the inner surface of the flexible material defines the inside of the flexitank (e.g., an inner cavity). Unless specified otherwise, in an embodiment of the flexitank in which one or more bags are disposed inside of one or more other bags, the “outer surface” of the flexitank refers to the outermost surface of the outermost bag or layer, while the “inner surface” of the flexitank refers to the innermost surface of the innermost bag or layer, which surface is designed for, or capable of, contact with the cargo, e.g., the liquid or solids that are being contained or held by the flexitank. Thus, for example, a multi-layer flexitank may have one or more intermediate layer(s) that is/are sandwiched between 2 other layers, which intermediate layer(s) provide(s) neither an outer flexitank surface nor an inner flexitank surface. The outer surface of the flexible material defines the outside of the flexitank. The flexitank is necessarily capable of holding (containing) any of a variety of flowable materials, such as any liquid (such as wine), or a slurry or granular solid particles (e.g., coffee beans or rice). The flexitank can be in a filled (partially filled, substantially filled, or totally filled) state (condition), for example, if liquid occupies the inside of the flexitank. Alternatively, the flexitank can be in an empty (unfilled) state (condition). As discussed below, the flexitank includes not only the flexible part (e.g., the bags) but also at least one opening. The flexitank that includes separate independent layers in certain embodiments also includes at least a fitting corresponding to at least one opening, which fitting can include one or more flanges or any mechanical fitting that clamps the layers together around the opening. The flexitank is in certain embodiments “elongated” which, as used herein, means that the flexitank has a length and a width, with sides that define the length (e.g., opposing sides) that are longer than the ends (e.g., opposing ends) which define the width. In certain embodiments, the flexitank is seamless along its length and can be formed from multiple tubes, as discussed in the '982 application, discussed below. When the flexitank is empty and is lying flat on the ground or other horizontal surface (e.g., the inside floor of a rigid shipping container), the flexitank is in certain embodiments rectangular. In the rectangular embodiment, the two length-wise sides of the rectangle are parallel to one another; and the two ends of the rectangle are also parallel to one another. When the flexitank is filled (substantially or totally), it has a length and a width, and also has a height. When the flexitank is filled, in certain embodiments it has an oblong shape. For example, a flexitank that is substantially or totally filled can be pillow-shaped, as shown in certain drawings herein. The flexitank has an overall size, including all its dimensions, such that it is capable of fitting into a rigid shipping container, both in an empty state and in a filled state. For example, a flexitank can have a length of from 5, or 15, or 20 feet, to 30, or 50, or 60 feet. That flexitank can have a width of from 3, or 4, or 5 feet to 6, or 8, or 12 feet. The flexitank can have a height (when filled) of from 1, or 2, or 3 feet to 4, or 7, or 10 feet. The flexitanks have dimensions (length, width and height) such that, in both an empty and filled condition, they can fit inside of whatever rigid container they are used with. They can have a volumetric capacity ranging anywhere from 5,000 liters to 30,000 liters. The flexitank can have a plurality of different components, including the bags or sheets of which the flexitank is made. For example, as noted above, certain flexitanks include a combination of bags (sometimes also referred to as “bladders”), in which bags are disposed within other bags. Certain examples of a flexitank are disclosed in U.S. Ser. No. 11/124,982, Publication No. US 2006/0251343 (“982 application”). All the parts of that application referring to “flexible multi-layer containers,” and the manner of making them, are hereby incorporated by reference, including the flanges and fittings, are also incorporated by reference. Specifically, the parts of Publication No. US 2006/0251343 that are incorporated herein by reference are FIGS. 1-20 and paragraphs [0031]-[0060].

The flexitank may also have one or more openings (apertures) in the flexible material itself by which air or cargo (liquid or granular) can be introduced to, or discharged from, the inside of the flexitank. Examples of such openings include a main or primary granular product input opening, a secondary granular product opening, one or more fluid inlet openings, one or more slurry discharge openings, and/or one or more vent openings. Other components are structures associated with each of the openings such as, for example: a discharge valve, for example a ball valve with a handle that is capable of being rotated from a closed position to an open position, or other kind of valves such as gate valves; check valves for allowing flow of fluid or slurry in one direction but not another; one or more fittings for one or more discharge valves that may include one or more flanges; one or more vent lines associated with a vent opening for releasing air or other gas from the inside of the flexitank; and one or more fittings for the vent lines that may include one or more flanges. Examples of fittings are disclosed in the '982 application referenced above. Any flexitank referenced herein may include at least one independent inner layer (e.g., an inner bag or liner) that is disposed inside another independent layer (e.g., an intermediate bag or liner), which is disposed inside yet another independent layer (e.g., an outer bag or liner). Those three layers can be regarded as three independent bags (e.g., bladders) combined to form a single composite bag. Examples of a flexitank that includes a combination of three bags, layers or liners are disclosed in the '982 application referenced above. Materials of construction of fittings, openings, valves, and conduits are largely dictated by the fluids and slurries expected to be handled, shipped, and/or off-loaded, as well as temperature and pressures expected in the systems. Polycarbonate and stainless steel have been used with success for most fluids and slurries.

Certain claims may include the term “container,” without being modified by the word “flexible.” As used herein, the term “container” when used without the modifier “flexible” refers to a rigid container, exemplified by the container 112 depicted in the drawings. The term “container” as used herein (rigid container) is defined as any rigid, metal box-like structure having two opposing vertically disposed side walls that have a length of at least 10 feet and in certain embodiments up to 60 feet; a height of at least 6 feet and in certain embodiments up to 12 feet; and a width (corresponding generally to the space between the two opposing side walls) of at least 6 feet and in certain embodiments up to 12 feet. The container also has a floor that has substantially the same length as the two side walls, and one end wall that is disposed between the side walls at the end of the container, which shall be referred to herein as the “rear wall” (also called the “closed end wall,” or the “closed end” or the “end wall”) of the container. The container also has an end opposite the closed end, which end shall be referred to herein as the “front end” or “open end” of the container. The container has one or more doors, which are flat members positioned at or proximate the open end that are capable of swinging open or closed. At least one embodiment of the container also has a top member, or “lid,” which is used to secure the flexitank inside the container during transportation (shipping). In certain embodiments, the lid is formed of a grating with bars that are formed in crisscross arrangement. Each of the side walls, and the rear wall, has an inside (inner) surface, and an outside (outer) surface. As shown in certain drawings herein, each container has an overall inside surface, which is irregular or corrugated (sometimes referred to as having “lazy” corrugations) but is nevertheless considered “substantially planar” as that term is used herein. As discussed in greater detail below, the overall surface of each of the rigid container walls has sub-surfaces (on the inside and outside of the container), which are discussed in greater detail herein and are also themselves referred to as “surfaces.” Also, for clarification, when reference is made herein to any container that has flexible walls, that container will be referred to either as a flexitank or a “flexitank,” or in certain instances that container will be referred to as a “sleeve.”

Any rigid “container” referenced herein is intended to include both a shipping container and truck trailer container. That is, the shipping container and the truck trailer container each qualify as a “container” as defined above. For example, each of them has a structure with the dimensions referenced above. The term shipping container (also called a “cargo container”) is well-known to persons involved in the shipping industry. The shipping container is capable of being used to ship (transport) large quantities of cargo over long distances, typically over water, on ships or barges, or over land on railway cars. A truck trailer container, on the other hand, is a container that also includes a chassis, and wheels, and a structure for attaching chassis to any truck having a diesel engine.

Various specific embodiments disclosed herein include at least one novel type of upright support system apparatus. As used herein, the term “upright support system” itself broadly means any structure disposed between a filled or partially-filled flexitank that is located inside the rigid container and the inside surface of a side wall of the container. There are various types of upright support system assemblies that have been used in the past in between a flexitank and the doors of a container, but thus far none has ever been designed to function between the side walls of a shipping container and a flexitank. Certain upright support system assemblies that have been used in the past between the doors and the flexitank include blocking structures which include a rectangular structure placed on the floor of the container between the flexitank and the inside of the container door(s), which structure includes an opening through which a discharge valve member can protrude, and which structure includes bolts that fit into the rigid container lashing channels. Another type of upright support system assembly used in the past between the doors of the container and the flexitank includes reinforcing cross-bars which are positioned horizontally and/or vertically to separate the filled flexitank from the inner surface of the door(s), and to thus restrain the flexitank. Upright support system assemblies can also include a flexible sheet, e.g., a tarp that is tied to the cross-bars and/or to struts that are an integral part of the container. See also assignee's non-provisional U.S. patent application Ser. No. 12/616,825, filed Nov. 12, 2009, claiming priority from provisional patent application Ser. No. 61/115,794, filed Nov. 18, 2008, and Ser. No. 61/215,706, filed May 8, 2009.

Shipping containers may include a sleeve. As used herein, the term “sleeve” is itself broadly defined to mean any flexible structure that can be placed inside a rigid container to provide a barrier between the outer surface of the flexitank and inner walls of the container, and has at least a floor with two opposing side walls (panels) and a rear wall (panel). In one or more specific embodiments, the sleeve is a flexible abrasion vapor containment structure. Such a structure is flexible and also serves to protect the flexitank from experiencing abrasion, which has the potential for leakage. Such a structure also prevents vapor from passing through the layer(s) of the sleeve by virtue of including a layer that is vapor-impermeable. The sleeve fits into a rigid container, and is sized accordingly. The sleeve is, certain embodiments, open at the top, so that the top surface of the flexitank can be viewed during shipment. The term “sleeve” is itself not restricted to any particular shape, size, or material. As discussed below, at least one version of the sleeve is box-like in shape, and has a horizontally disposed floor and four vertical walls (panels) configured to fit on the inside of a rigid container (e.g., a shipping container). The boxlike version has creases along the four lower edges of the side walls (panels) where those side walls (panels) adjoin the flexible rectangular floor. As an alternative to the box-like version, at least one version of the wear-sleeve is rounded at the places where the floor of the sleeve adjoins the side walls (panels), such that, unlike the aforementioned box-like version, there is no crease between the floor and each side wall (panel) of the sleeve that separates the flexitank from the inside walls of the rigid container. The rounded version of the sleeve is thus more tube-like than box-like in shape. At least one version (embodiment) of the sleeve has a floor panel that, when placed into a rigid shipping container, is disposed horizontally on the container floor, and also has at least three flexible sleeve walls that, when the sleeve is placed into a rigid shipping container, are substantially vertically oriented so that the sleeve provides a barrier between the outer surface of the flexitank and inner walls of the container. In certain embodiments, the sleeve has at least four flexible walls (panels) that are vertically oriented, and all vertical walls (panels) are integrally attached along one edge to the sleeve floor. Other versions of the sleeve, and various aspects or features of those versions, are described below.

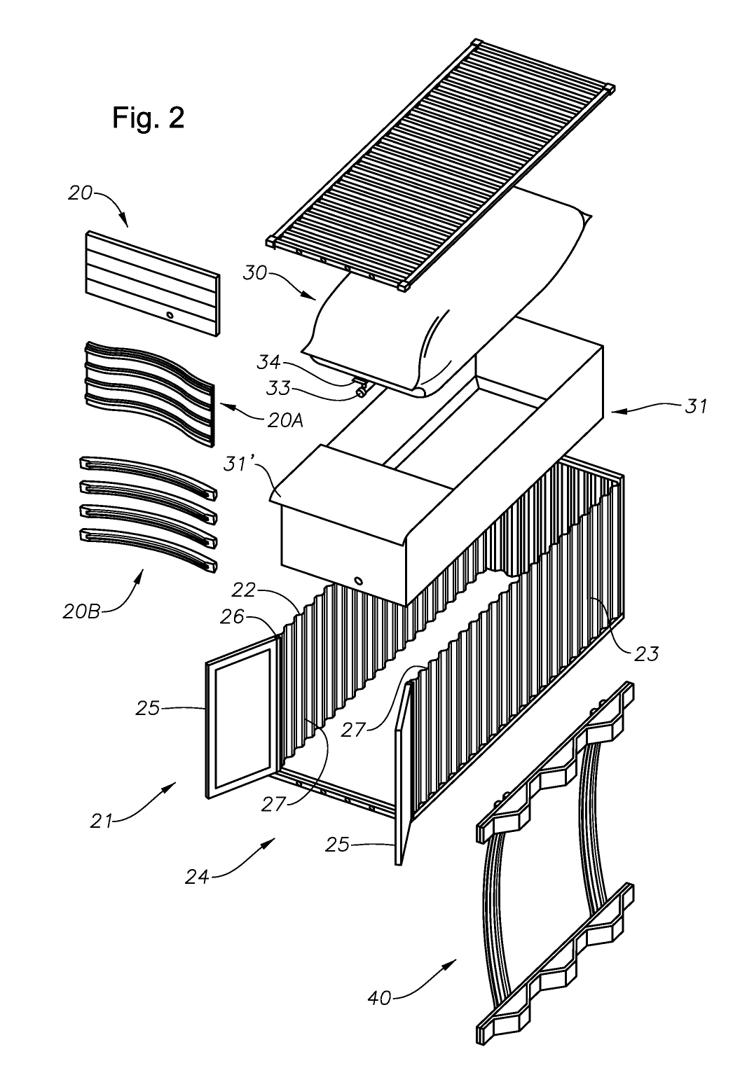

Referring now to the figures, a shipping container 21 (FIG. 1) for shipping bulk product includes container side walls 22 and 23 defining with its roof and floor an access opening 24 (i.e., door-supporting end), at least one door 25 (two doors being illustrated) supporting on hinges 25′ for closing the access opening 24, and a framework 26 (also called “header”) on an end of the side walls 22 and 23 adjacent the access opening 24 supporting the doors 25. The framework 26 forms channel features 27 in the sidewalls 22, 23 adjacent the opening 24 and along the side walls 22 and 23. Typically, an upright support system is formed within the container 21 as illustrated in FIG. 2 for preventing damage to the doors 25, but heretofore no provision has been made to protect the side walls 22, 23, aside from ribs built-into the side-walls themselves, which in many cases are not sufficient to prevent damage to the side walls.

FIG. 2 illustrates a flexitank 30 (such as “BIG RED™ FLEXITANK” made by Environmental Packaging Technologies, Houston Tex.), and a liner 31 for supporting the walls of tank 30 against the container side walls 22, 23. As mentioned above, typically in such cases an energy-absorbing apparatus 20, 20A, or 20B is required to prevent the end of the flexitank 30 from flexing and pressing against doors 25, but until now no provision has been made or suggested for reinforcing the side walls 22, 23 of the container. The illustrated flexitank 30 includes a fill tube 33 with shut-off valve 34. FIG. 2 illustrates an embodiment 40 of a removable, upright, stackable side wall support apparatus useful for supporting container sidewalls.

It has now been recognized that container side walls 22, 23 may require support as well as the doors. For example, when a shipping container is shipped using sea-going vessels, the shipping container may experience rolling motion. This rolling motion may be a problem as well during truck transport on freeways having curves, such as highway interchanges and the like, and during air transport. As discussed above, one past proposed solution is to include ribs in the side walls; another proposal was to have support beams extending horizontally from side wall to side wall, near the roof of the container. Both of these options has drawbacks, and do not fully protect the side walls nor the flexitank or other tanks inside the shipping container during significant rolling motion.

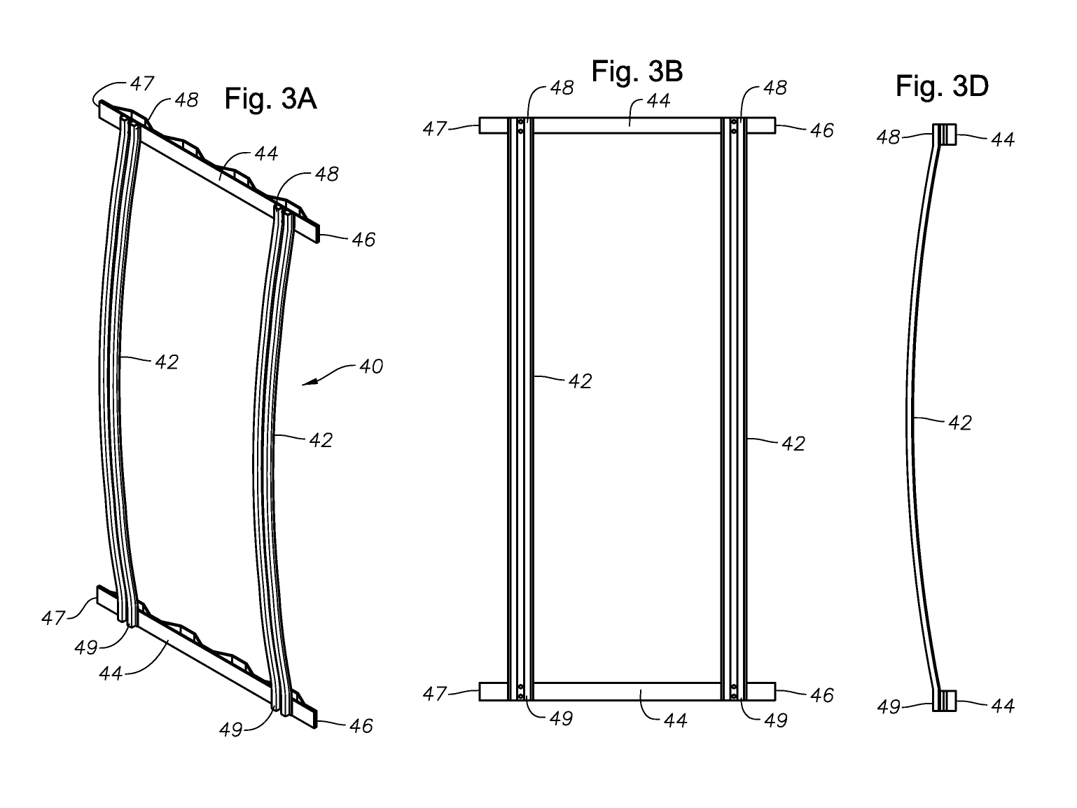

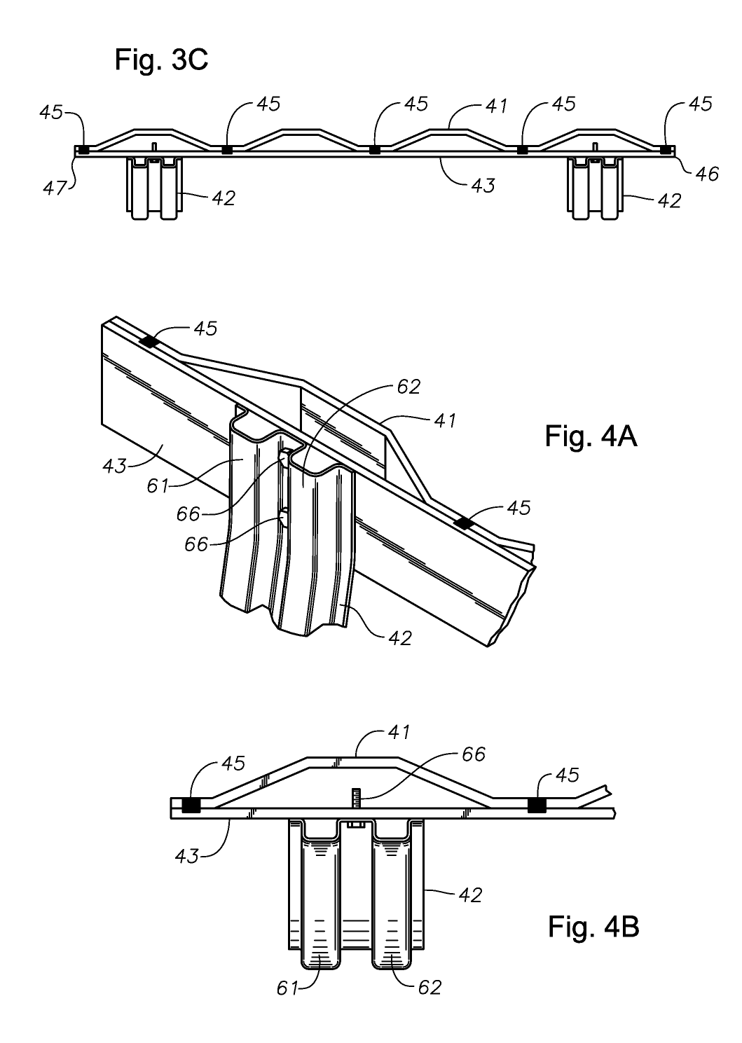

A first embodiment 40 of a removable, upright, stackable side wall support system apparatus for a shipping container is illustrated in more detail in FIGS. 3A-D. Embodiment 40 includes a pair of mounting brackets 44 separated by a distance equal to or less than a height of the container side walls 22, 23, mounting brackets 44 each comprising first and second bars 41, 43 welded together at intermittent locations along their lengths. One of the bars, bar 41, has a corrugated shape to fit matingly into the corrugations of side walls 22, 23 of the shipping container, while bar 43 is essentially flat. The side wall support system apparatus of embodiment 40 also includes two connecting beams 42 having ends 46, 47 removably fastened to mounting brackets 44 as illustrated. For added strength, bars 41 and 43 are welded or otherwise immobilized against movement past each other at locations 45. Instead of welds, these may be rivets, screws, or other fasteners. Welding provides exceptional service life and fewer man-hours to install the upright side wall supports into the containers. Ends 48, 49 of connecting beams 42 are fastened to mounting brackets 44 via bolts 66, although these too may be welds or other fasteners, such as rivets, in certain instances. Connecting beams 42 may also be referred to herein as “structural tubular beams” and, in embodiment 40, comprise tubular structures 61, 62. Connecting beams 42 are configured to withstand impact loads of over 75,000 pounds, preventing the product from shifting against the side walls 22, 23 of shipping container during transport. In one form, the connecting beams 42 are made of steel having a 120 KSI tensile strength and 1.2 mm thick, and are linear. However, it is also contemplated that the connecting beams may be longitudinally-curved (i.e., “swept”) (as described below) so that energy from product shifting during transport is absorbed by flexure of the connecting beams without moving too close to the side walls 22, 23, as described below. Connecting beams 42 may have different sweeps and longitudinal curvatures.

The illustrated connecting beams 42 (FIGS. 3A-D) are tubular, and have a W-shaped cross-section, but may be other cross-section such as, but not limited to, B-shaped, D-shaped, U-shaped, and the like. Dimensions of the cross-section may vary for particular applications. It is contemplated that beams 42 will have cross-sectional dimensions of at least about 2 inches (in a plane perpendicular to the side walls 22, 23) and 3 inches (in a plane parallel to the side walls 22, 23), and in many applications cross-sectional dimensions of at least about 3 inches×3½ inches. Connecting beams 42 and hence upright support 40 may have different sweeps/longitudinal curvatures depending on particular functional requirements. For example, the connecting beams in FIGS. 3-6 are longitudinally swept (i.e., curved longitudinally) to position their middle at least about 1 inch inward toward an interior of the shipping container compared to ends of the beam. Notably, this “inboard bend” (i.e., sweep) in the bars can cause a middle of the upright support system to be several inches away from the side walls 22, 23, the depth being dependent on the stress expected in a particular situation. This inboard bend/sweep allows the upright side wall support system 40 to flex and absorb energy. The illustrated energy-absorbing upright support system 40 can absorb up to 140,000 pounds force. Clamps can be used to secure the upright support in place on the side walls 22, 23 if it is desirable to more securely hold the upright supports 40 in place (rather than to rely only on gravity hold them in place).

Reference is made to U.S. Pat. No. 5,092,512; U.S. Pat. No. 5,454,504; U.S. Pat. No. 7,530,249 and U.S. 2009/0255310, all assigned to Shape Corporation, the entire contents of each of which are incorporated herein in their entirety for the purpose of providing a complete and adequate disclosure of roll forming processes that can be used for forming different connecting beams.

The method of constructing the upright side wall support systems includes roll forming the W-shaped tubular connecting beams 42 (and if desired, also sweeping the beams 42 during or after roll forming). Beams 42 are then connected to mounting brackets 44 using bolts 66, by welding or other means. One method of constructing a tank-supporting energy absorber upright support system 40 within a shipping container 21 includes placing the liner 31 vertically within the container 21, and then placing the tank 30 in the container 21. The upright side wall supports are then positioned on the side walls by mating the corrugation of bar 41 with the corrugations of a side wall 22 or 23 of the shipping container 21. The method further includes removing all components of the upright side wall support system 40 and reusing them. Notably, the components of the present upright side wall support system 40 are relatively light-weight, such that they are a much lower percent of the overall product shipment's total weight. Further, “assembly” of a given upright side wall support system 40 can be accomplished relatively quickly, and without the need for special tooling or special installation skills.

The energy-absorbing upright side wall support system 40 can be constructed to be positioned anywhere along a side wall 22, 23 of container 21, in other words substantially parallel thereto. Thus, multiple upright side wall support systems 40 can be used to support different sections of the container side walls in a manner preventing undesired side shifting of product within the container 21.

FIGS. 4A and 4B are detailed perspective and detailed side elevation views, respectively, of the connection between mounting bracket 44 and a connecting beam 42 of embodiment 40 illustrated in FIGS. 3A-3D. Illustrated in detail are the relationships between the various components, including illustrating how connecting beam 42, having tubes 61, 62, is bolted to mounting bracket 44 using bolts 66. Weld areas 45 are also illustrated.

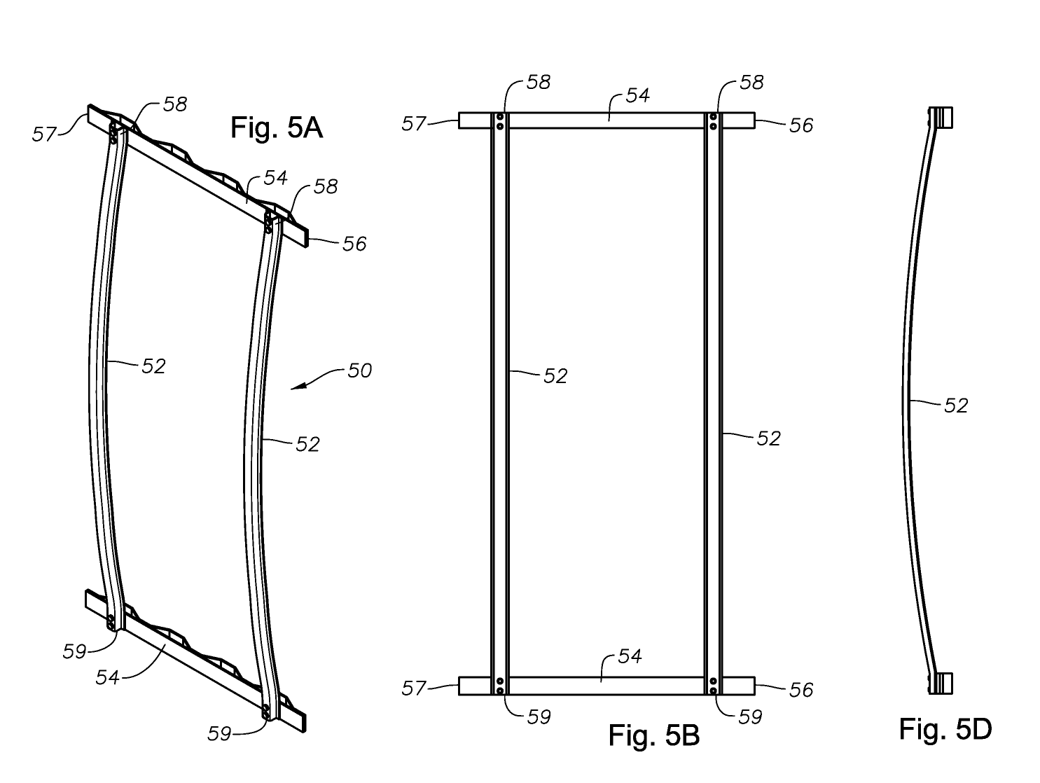

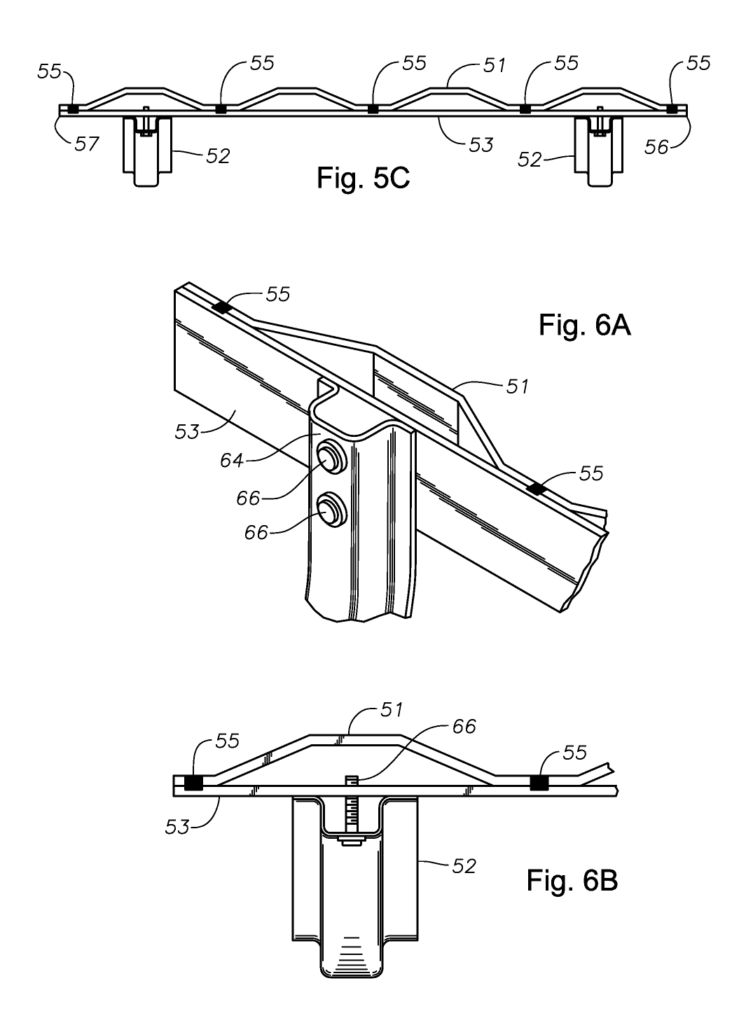

FIGS. 5A-5D are schematic perspective, front elevation, plan, and side elevation views, respectively, of a second embodiment 50 of an upright support system apparatus in accordance with the present disclosure. Second embodiment 50 is similar to embodiment 40, but differs in the type of connecting beam 52 used. Embodiment 50 includes a pair of mounting brackets 54 separated by a distance equal to or less than a height of the container side walls 22, 23, mounting brackets 54 each comprising first and second bars 51, 53 welded together at intermittent locations along their lengths. One of the bars, bar 51, has a corrugated shape to fit matingly into the corrugations of side walls 22, 23 of the shipping container, while bar 53 is essentially flat. The side wall support system apparatus of embodiment 50 also includes two connecting U-shaped cross-section beams 52 having ends 56, 57 removably fastened to mounting brackets 54 as illustrated. For added strength, bars 51 and 53 are welded or otherwise immobilized against movement past each other at locations 55. Instead of welds, these may be rivets, screws, or other fasteners. Ends 58, 59 of connecting beams 52 are fastened to mounting brackets 54 via bolts 66, although these too may be welds or other fasteners, such as rivets, in certain instances. Connecting beams 52 in embodiment 50 comprise a single tubular structure 64. Connecting beams 52, like beams 42 in embodiment 40, are configured to withstand impact loads of over 75,000 pounds, preventing the product from shifting against the side walls 22, 23 of shipping container during transport. In one form, the connecting beams 52 are made of steel having a 120 KSI tensile strength and 1.2 mm thick, and are linear. However, it is also contemplated that the connecting beams may be longitudinally-curved (i.e., “swept”) (as described below) so that energy from product shifting during transport is absorbed by flexure of the connecting beams without moving too close to the side walls 22, 23, as described below. Connecting beams 52 may have different sweeps and longitudinal curvatures.

The illustrated connecting beams 52 of FIGS. 5A-D are tubular, and have a U-shaped cross-section. Dimensions of the cross-section may vary for particular applications, and may have cross-sectional dimensions similar to the W-shaped cross-section of beams 42 of embodiment 40, and may have different sweeps/longitudinal curvatures depending on particular functional requirements, as explained previously.

FIGS. 6A and 6B are detailed perspective and detailed side elevation views, respectively, of the connection between mounting bracket 54 and a connecting beam 52 of embodiment 50 illustrated in FIGS. 5A-5D. Illustrated in detail are the relationships between the various components, including illustrating how connecting beam 52, having tube 64, is bolted to mounting bracket 54 using bolts 66. Weld areas 55 are also illustrated.

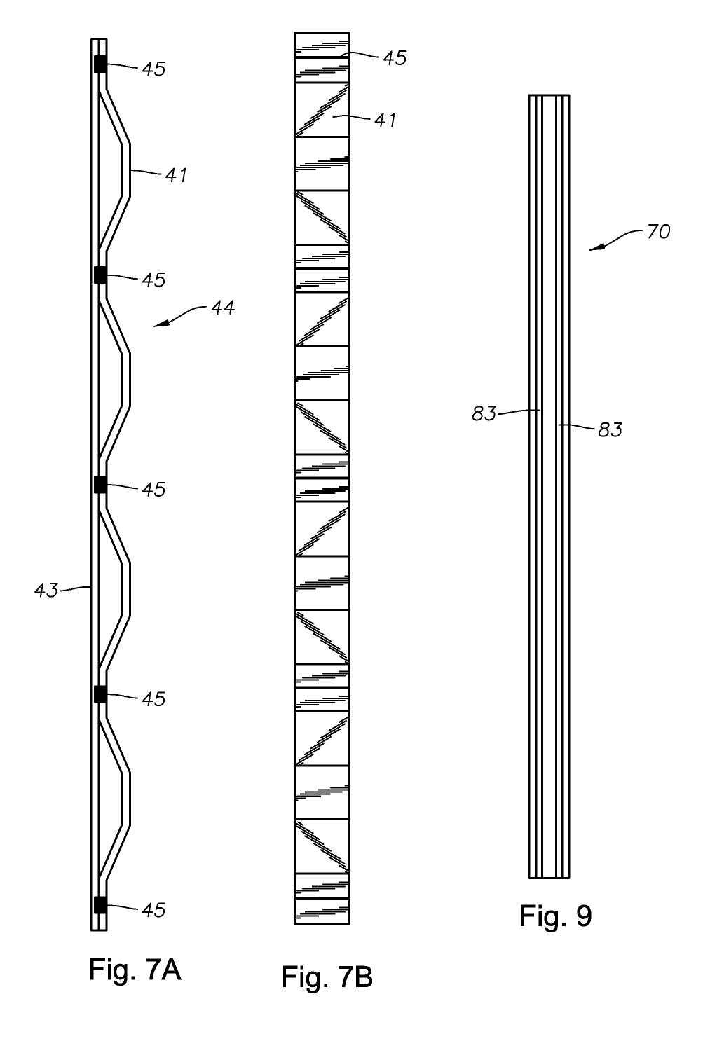

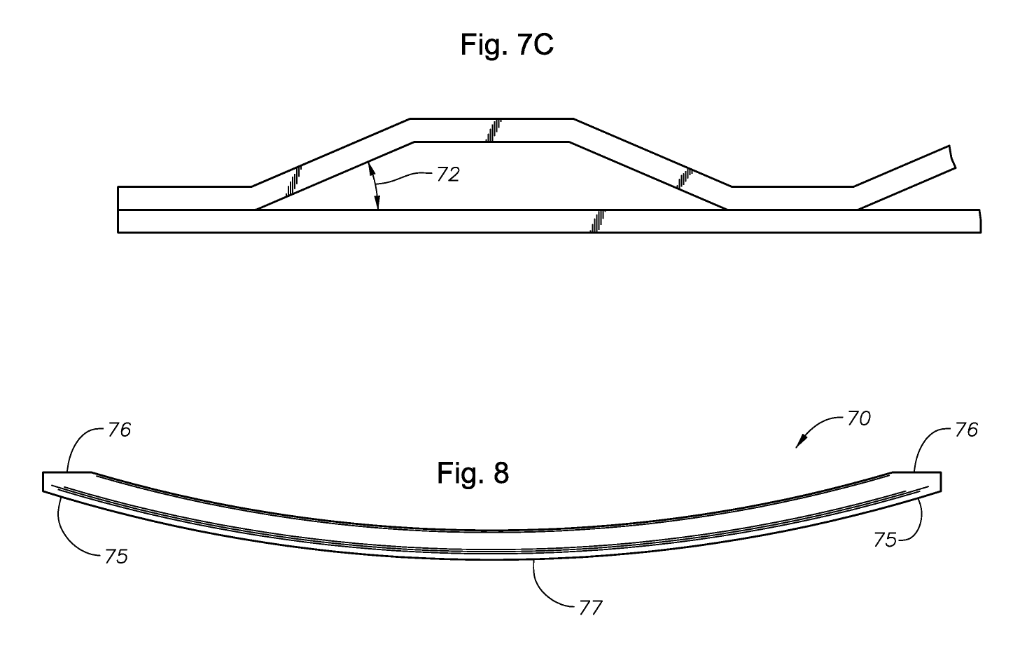

FIGS. 7A, 7B, and 7C are side elevation, plan, and detail views of a mounting bracket 44 of this disclosure, illustrating one method of attaching corrugated bar 41 to flat bar 43. In this embodiment the bars are tack welded together at areas 45. It should be noted that corrugated bar 41 may be formed from a single piece of metal that is bent at the various angle vertices, or multiple pieces (41A, 41b, 41c, etc) may be welded together and to flat bar 43 at weld areas 45. FIG. 7C also illustrates one angle 72 useful in the mounting brackets of this disclosure. In the embodiment illustrated in FIG. 7C, angle 72 is 23 degrees, however, angle 72 may vary as required, and may range from about 15 to about 30 degrees, or from about 17 to about 25 degrees. A larger angle would be expected to provide greater support, or greater resistant to compression, while a smaller angle would be expected to provide relatively less support.

FIGS. 8-10 are plan, front elevation, and transverse cross-section of a connecting beam useful in the support systems of this disclosure, and FIG. 11 is an enlarged plan view of the end of one such beam. Connecting beam 70 (also sometimes called “structural tubular beams”) has ends 75 angle cut on one side to form co-planar “flat” rear mounting surfaces 76. (Alternatively, it is contemplated that a flat rear surface 76 can be formed by deforming an end of the bar (see FIGS. 15-18), and/or by angle cutting and then welding a flat plate onto an end of the bar (see FIGS. 12-14) to provide a desired surface profile.) As a result, the curved front surface 77 and the flat rear surface 76 combine at the end 75 to define a depth dimension 78 and shape that allows the ends to be connected to the mounting brackets.

In one form, connecting beams 70 may be made of steel having at least 120 KSI tensile strength (or potentially 220 KSI tensile strength or more) and 1.2 mm thick (or potentially 0.8 mm thick or less). Also, the beams 70 can be swept (i.e., bowed longitudinally) several inches, such as 4-10 inches, so that energy from product shifting during transport is absorbed by beam flexure. The beams are preferably roll formed to have a constant tubular cross-section (or multi-tubular cross-section) along a majority of their length, and have ends modified as needed in secondary operations.

The illustrated beam 70 (FIGS. 8-11) is a B-shaped bar with spaced apart tubes 81 and 82, with a front wall of the bar having a channel rib 83 centered over each tube. It has been found that the illustrated cross-sectional shape of the illustrated beam 70 with channel rib over each tube can provide significant improved bending strength, making the actual beam bending strength much closer to the theoretical beam bending strength.

The illustrated beam 70 has its ends angle cut to form a flat co-planar rear mounting surfaces 76 that combine with the angled front surfaces to form a trapezoid shape at its configured ends. Notably, the configured ends can be substantially any shape desired, but in some embodiments may be shaped for mating engagement with receptacles of the large shipping container. It is noted that the configured ends of the beams can be made in different ways, depending on functional requirements of particular upright support systems. For example, a second bar 80 (FIGS. 12-14) is a single tube beam that could be used in place of beam 70. Beam 80 includes configured ends that are angle cut but then a flat plate is welded to form its flat engagement area on the side wall-adjacent side surface. By this construction, ends of the bars 80 are configured/shaped to optimally engage the flat bar 43 of the mounting bracket 44. Alternatively, in place of the flat welded plate, it is contemplated that a molded spacer could be formed that fits onto the open end of the beam, the spacer being made of plastic material and creating a desired end shape.

FIGS. 15-18 illustrate a connecting beam 90 similar to beam 70 in cross-section. Specifically, beam 90 includes spaced tubes 91 and 92 and channel ribs 93 in its wall 94 over each tube. However, at the ends 95, the wall 96 is deformed at locations 97 toward the interior wall 94 until it abuts the associated channel rib 93. This forms a configured end with trapezoidal shape similar to the ends of bars 70 and 80, and which is well suited to engage the flat bar 43 of the mounting bracket 44.

In curved connecting beams, such as beams 70, 80, and 90, a tie rod may be used to further strengthen the beams.

It is contemplated that the scope of the present inventive concepts are sufficiently broad to include connecting beams having many different cross-sectional shapes, including open-channel bar shapes, such as a C channel shape, or an I bar shape, or a Z channel shape.

The present upright side wall support systems are particularly advantageous when used with flexitanks, since the sheet walls of these tanks are very flexible and require support to avoid pressing on container side walls. Specifically, flexitanks allow a maximum amount of liquid material to be transported within a container 21, such as 16,000 to 24,000 liters in a typical large rectangular shipping container, since they take up a minimal amount of space within the container and further since the flexitank generally expands to a shape defined by the container. Also, they minimize the amount of packaging materials and simultaneously minimize waste (i.e., a greater amount of the weight shipped is actual liquid product, and also less packaging must be thrown away at the final destination.) Also, the flexitank and its liner typically can be made of recyclable materials and of lower cost materials, making the overall shipping system much more environmentally friendly than existing systems. Contrastingly, barrels and/or most other shipping containers must be disposed of (which is expensive and not environmentally friendly) or reused (which is difficult to do without cross contamination from earlier shipped materials and also which can require clean-out processes that are expensive and environmentally unfriendly). However, flexitanks require not only a secure and stable bulkhead, such as the illustrated bulkhead 20, but also secure and stable side wall support systems.

The above-illustrated connecting beams are preferably roll-formed tubular beams made from sheet metal of desired strength and thickness, and welded into a permanent shape. The beams include one or more tubes, and have a cross-section for optimal bending strength. The beams preferably provide a flat surface for engaging the mounting brackets which in turn supports the product containers or tanks within the large shipping containers. The beams can be made to have a predetermined longitudinal sweep that increases flexure and further protects the container side walls. The sweep can be made during the roll forming process or thereafter in a secondary operation.

Flexitanks may have anywhere from 1 to 2, or from 1 to 4, or from 1 to 6, or even more layers. Two typical embodiments are 2-layer materials, one embodiment comprised of 2 14-mil layers of polyethylene, and the second comprised of one 14-mil ply or layer of EVOH (ethylene vinyl alcohol) and one 14-mil layer of polyethylene. Other materials which may be employed include, but are not limited to those wherein one layer is selected from polymers including amorphous poly(ethylene terephthalate) (APET), polypropylene (PP), high-density poly (ethylene) (HDPE), poly(vinylchloride) (PVC), poly(styrene) PS, and mixtures, copolymers, combinations and layered versions thereof, wherein each layer may be a mixture or copolymer of two or more of these. The second layer may be a mono layer, a homopolymer or blends of polymers, or a coextruded film comprised of distinct multiple layers with homopolymer or blends of polymers within each layer. Polymers that may be used in the second layer may be selected from ethylene-vinyl alcohol (EVOH), poly(ethyl)methacrylate (EMA), high-melt strength LDPEs, and metallocenes such as metallocene poly(ethylenes), also known as plastomer metallocene poly(ethylenes), low-density poly(ethylene) (LDPE), ultra-low density linear poly(ethylene) (ULLDPE), linear low density poly(ethylene) (LLDPE), K-resin, PP, poly(butadiene), and mixtures, copolymers, and layered versions of two or more of these, wherein each layer may be a mixture, copolymer, or some other combination of these polymers. As used herein the term “copolymer” includes not only those polymers having two different monomers reacted to form the polymer, but two or more monomers reacted to form the polymer.

The flexible material 2 may meet the standards as detailed in Table 1.

TABLE 1

| | | |
|---|---|---|
| Tensile Strength | ASTM D-882 | PE 68 ppi |
| | | EVOH 35 ppi |
| Peak Elongation MD | ASTM D-882 | PE 1000% |
| | | EVOH 655% |
| Puncture Resistance | ASTM D-3420 | PE 4000 (dart) |
| (lbs) | | EVOH 1500 (dart) |
| Oxygen Permeation | ASTM D-3985 | PE 20 cc/100 in 2/day Max. |
| | | EVOH 0.027 cc/100 in 2/day |
| | | Max |
| Moisture Transfer | ASTM F-1249 | PE 0.03 |
| (perms) | | EVOH 0.05 |
| Effective Temperature | | 167° F. to −23° F. or |
| Range | | 75° C. to −5° C. |

“Oxygen transport (or transmission) rate (OTR)” as used herein designates oxygen transport rate as measured by ASTM D3985-81 or any equivalent protocol. See also ASTM F1307-02.

Although only a few exemplary embodiments have been described in detail above, those skilled in the art will readily appreciate that many modifications are possible in the exemplary embodiments without materially departing from the novel teachings and advantages of systems, kits, and methods described herein. Accordingly, all such modifications are intended to be included within the scope of this disclosure as defined in the following claims. In the claims, no clauses are intended to be in the means-plus-function format allowed by 35 U.S.C. §112, paragraph 6, unless “means for” is explicitly recited together with an associated function without any structure being recited. “Means for” clauses are intended to cover the structures described herein as performing the recited function and not only structural equivalents, but also equivalent structures.

1. In a large shipping container including container side walls defining an access opening and at least one door for closing the access opening, the side walls being corrugated, a removable, upright, stackable side wall support system apparatus comprising:
a) a pair of mounting brackets, the mounting brackets separated by a distance equal to or less than a height of the side walls, the mounting brackets each comprising first and second bars welded together at intermittent locations along their lengths, one of the bars having a corrugated shape to fit matingly into the corrugations of the side walls of the shipping container; and
b) at least two connecting beams having ends removably fastened to the mounting brackets.

2. The support system apparatus defined in claim 1, wherein the connecting beams have a cross-section allowing two or more apparatus to be stacked after being removed from the shipping container.

3. The support system apparatus defined in claim 1, wherein the connecting beams have a structure selected from the group consisting of at least one tube section (D-beam), at least two spaced-apart tube sections (B-beam), rectangular, W-shaped cross-section, and U-shaped cross-section.

4. The support system apparatus defined in claim 1, wherein the connecting beams are fastened to the support brackets using one or more bolts.

5. The support system apparatus defined in claim 1, wherein the connecting beams are curvilinear and curve away from the corrugations of the mounting brackets and the shipping container walls.

6. The support system apparatus defined in claim 1 comprising two mounting brackets and two connecting beams, the connecting beams fastened to the mounting brackets at equal distances away from respective ends of the mounting brackets.

7. The support system apparatus defined in claim 6 wherein each mounting bracket has a length A, and each connecting beam is fastened to the mounting brackets at a distance away from ends of the mounting brackets ranging from 0.1A to 0.3A.

8. The support system apparatus of claim 5 wherein the connecting beams have a length B and curve such that a point that is furthest away from a line including both ends of the connecting beam ranges from 0.01B to 0.1B.

9. The support system of claim 1 wherein the ends of each of the connecting beams include end sections that are co-linear and aligned.

10. The support system apparatus defined in claim 1, wherein ends of the at least one connecting beam include a deformed and flattened side surface.

11. The support system apparatus defined in claim 1, wherein the connecting beam is made of sheet material having a material strength at least about 40 KSI tensile strength.

12. The apparatus defined in claim 11, wherein the material has a tensile strength of at least about 80 KSI.

13. The apparatus defined in claim 12, wherein the material has a tensile strength of at least about 120 KSI.

14. The apparatus defined in claim 1, wherein the at least one connecting beam is longitudinally swept so as to position a middle of the bar at least about 1 inch forward of ends of the bar.

15. The apparatus defined in claim 1, wherein the at least one connecting beam's ends are configured to releasably extend into and directly engage the side walls of the container.

16. The apparatus defined in claim 1, including brackets attached to the side walls of the container and engaging the ends of the at least one connecting beam.

17. An energy-absorbing, removable, upright, stackable support system apparatus for use in strengthening side walls of a shipping container, the shipping container including container side walls defining an access opening and opposing channel features, at least one door for closing the access opening, the upright support system apparatus comprising:
a) a pair of mounting brackets, the mounting brackets separated by a distance equal to or less than a height of the side walls, the mounting brackets each comprising first and second bars welded together at intermittent locations along their lengths, one of the bars having a corrugated shape to fit matingly into the corrugations of the side walls of the shipping container; and
b) at least two connecting beams having ends removably fastened to the mounting brackets, wherein the connecting beams are curvilinear and curve away from the corrugations of the mounting brackets and the shipping container walls.

18. The apparatus defined in claim 17, wherein the connecting beams each include a swept center section.

19. The apparatus defined in claim 18, wherein the connecting beams each define a pair of spaced-apart tubes.

20. A method of constructing an energy absorbing upright support system for side walls within a shipping container or truck trailer comprising:
a) providing a pair of mounting brackets, the mounting brackets separated by a distance equal to or less than a height of the side walls, the mounting brackets each comprising first and second bars welded together at intermittent locations along their lengths; and
b) at least two connecting beams having ends removably fastened to the mounting brackets, wherein the connecting beams are curvilinear and curve away from the shipping container walls,
wherein the upright support system forms a temporary structure that prevents product from unacceptably shifting against a container corrugated side wall.

21. The method of claim 20 wherein one of the bars has a corrugated shape to fit matingly into corrugations of the side walls of the shipping container.

22. A method of constructing a temporary upright support system for side walls in a shipping container comprising:
preforming at least one connecting beam of metal;
supporting ends of the at least one connecting beam vertically using mounting brackets positioned adjacent the side walls of a container to form an upright support system preventing product from shifting against the side walls during shipment;
dismantling the upright support system; and
later reusing the system in another container.

23. The method of claim 22 wherein the side walls are corrugated.

24. The method defined in claim 23, including sweeping the at least one connecting beam so that, when positioned in a container-supported position, a center of the at least one connecting beam is spaced away from the at least one corrugated side wall a greater distance than ends of the at least one connecting beam.

25. The method defined in claim 23, including a step of attaching mounting brackets to the corrugated side walls of the shipping container on each side thereof, and attaching at the least one connecting beam to the corrugated mounting brackets, the mounting brackets having corrugated surfaces mating with the corrugations of the side walls.

26. The method defined in claim 22, including rollforming the connecting beam from sheet material of at least about 80 KSI tensile strength

27. The method defined in claim 22, including rollforming the connecting beam to have a cross-section defining at least a pair of tubes.

28. The method defined in claim 22, including placing a bulk liquid cargo vessel within the container and, after forming the upright support system, filling the vessel so that a side of the vessel presses against the upright support system.

29. A kit for supporting a planar or corrugated side wall of a shipping container when used with a full or partially full bulk liquid cargo vessel, the kit comprising:
a) a bulk liquid cargo vessel comprising at least one product inlet or at least one product outlet;
b) first and second conduits, the first conduit routing a fluid into the vessel, the second conduit routing product out of the vessel during off-loading;
c) an upright support system apparatus for supporting planar or corrugated side walls of the container comprising:
i) a pair of mounting brackets, the mounting brackets separated by a distance equal to or less than a height of the side walls, the mounting brackets each comprising first and second bars welded together at intermittent locations along their lengths, one of the bars having a shape to fit matingly into the shape of the side walls of the shipping container; and
ii) at least two connecting beams having ends removably fastened to the mounting brackets, wherein the connecting beams are curvilinear and curve away from the shipping container walls; and
d) means for deterring collapse of the vessel during off-loading of the product.

30. The system or kit of claim 29 wherein the vessel is a flexitank, and the flexitank is substantially seemless.

31. The system or kit of claim 30 wherein said means for deterring collapse are fasteners selected from one or more snaps, loops, hook and loop fasteners, and combinations thereof, securely attached to an external surface of the flexitank in a fashion so that the fasteners are able to engage in a cooperative, supporting fashion with a rigid container into which the flexitank has been placed, thereby substantially deterring collapse of the flexitank.
